(19) United States
(12) Patent Application Publication
(10) Pub. No.: US 2016/0316426 A1
(43) Pub. Date: Oct. 27, 2016

(54) LTE NETWORK ASSISTED POWER SAVING

(71) Applicant: QUALCOMM Incorporated, San Diego, CA (US)

(72) Inventor: Rajeev Kumar, San Diego, CA (US)

(21) Appl. No.: 14/696,855

(22) Filed: Apr. 27, 2015

(51) Int. Cl. H04W 52/02; H04W 48/20; H04W 12/06; H04W 48/10

(52) U.S. Cl. CPC H04W 52/0206; H04W 48/10; H04W 48/20; H04W 12/06; H04W 88/06

(57) ABSTRACT

A wireless communications system includes a base station to transmit and receive cellular signals and an access point to transmit and receive Wi-Fi signals. A system controller is coupled to the base station and the access point. The system controller receives a cellular signal from a client device via the base station and activates the access point in response to the cellular signal. The system controller further enables the client device to communicate with the wireless communications system, via the access point, using Wi-Fi signals.

### TECHNICAL FIELD

The example embodiments relate generally to wireless networks, and specifically to wireless networks including cellular base stations and Wi-Fi access points that share a backhaul connection.

### BACKGROUND OF RELATED ART

Modern wireless communications devices (e.g., mobile phones, tablets, computers, etc.) are often equipped with multiple wireless radios that allow the devices to communicate using various wireless communication standards and protocols. Example wireless communication protocols may include the IEEE 802.11 protocols (e.g., Wi-Fi), Bluetooth protocols according to the Bluetooth Special Interest Group, and Long Term Evolution (LTE). LTE is a set of enhancements to the Universal Mobile Telecommunications System (UMTS) mobile standard promulgated by Third Generation Partnership Project (3GPP). LTE communications may operate in portions of the licensed frequency spectrum (e.g., between approximately 700 MHz-2.6 GHz; may be known as LTE-L) and may operate in portions of the unlicensed frequency spectrum (e.g., around 5 GHz; may be known as LTE-U).

A client device with a cellular radio is typically connected to a wireless network via a cellular base station. For example, the client device may communicate with the base station using the LTE protocol. In some instances, a client device may also access the wireless network by communicating with a Wi-Fi access point (e.g., using the Wi-Fi protocol) in the wireless network. For example, the base station and the access point (AP) may be connected to the same backhaul network, which may be maintained and/or operated by a carrier or service provider. The backhaul network forms an intermediary connection between wireless sub-networks (e.g., provided by the base station and the AP) and a core network (e.g., the Internet).

It is often desirable to “offload” communications with a client device from a base station to an AP, for example, to reduce the load on the base station. However, maintaining the Wi-Fi radio on the client device in an active state may waste considerable power when no data signals are being communicated over the Wi-Fi link and/or no APs are within wireless range of the client device. For example, while the Wi-Fi radio is active, the client device may continually scan for APs in its vicinity. Similarly, maintaining an AP in an active state may also waste considerable power when no data signals are being communicated over the Wi-Fi link and/or no client devices are within wireless range of the AP. For example, while the AP is active, it may continually broadcast beacon frames.

Thus, it would be desirable to reduce the power consumption of Wi-Fi radios provided in wireless devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus are disclosed that reduce power consumption in wireless communication devices by selectively enabling Wi-Fi communications between a wireless communications system and one or more client devices. The wireless communications system includes a base station to transmit and receive cellular signals (e.g., based on an LTE standard), and includes an access point to transmit and receive Wi-Fi signals. A system controller is coupled to the base station and the access point. The system controller receives a cellular signal from a client device via the base station and activates the access point in response to the cellular signal. The system controller further enables the client device to communicate with the wireless communications system, via the access point, using Wi-Fi signals.

The system controller may activate the access point by first identifying a set of access points in the wireless communications system that are within wireless range of the client device, and then selecting the access point from the set of access points based at least in part on a proximity of the access point to the client device. For example, the access point may be the closest access point to the client device. Activating the access point may enable the access point to broadcast beacon frames and to respond to probe requests.

The system controller may enable the client device to communicate with the wireless network via the access point by activating a Wi-Fi radio on the client device in response to receiving the cellular signal. The Wi-Fi radio enables the client device to transmit and receive Wi-Fi signals. Activating the Wi-Fi radio enables the client device to scan for one or more access points (e.g., either actively, by broadcasting probe requests, or passively, by listening for beacon frames). The system controller may further provide a network key to the client device and the access point to enable the client device to authenticate with the access point.

If no wireless communications are detected on the Wi-Fi link between the client device and the wireless communications system, the system controller may deactivate the Wi-Fi link. For example, the system controller may prevent the access point from broadcasting beacon frames upon detecting that the client device has been idle for at least a threshold duration. The system controller may also prevent the Wi-Fi radio on the client device from broadcasting probe requests upon detecting that the client device has been idle for at least a threshold duration.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 shows an example wireless communications system within which the example embodiments may be implemented.

FIGS. 2A and 2B show example timing diagrams depicting selective activation and deactivation of Wi-Fi resources in a wireless network.

FIG. 3 shows an example sequence diagram depicting a backhaul-controlled activation of a Wi-Fi link between a client device and a wireless communications system.

FIG. 4 shows an example wireless communications system including a wireless sub-network comprising multiple access points within which the example embodiments may be implemented.

FIG. 5 shows a system controller for a wireless communications system in accordance with example embodiments.

FIG. 6 shows a flowchart depicting an example operation for activating Wi-Fi resources in a wireless network in response to a cellular communications signal.

FIG. 7 shows a flowchart depicting an example operation for controlling an activation and deactivation of Wi-Fi resources in a wireless network.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature and/or details are set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scope all embodiments defined by the appended claims.

As used herein, the terms “wireless local area network (WLAN)” and “Wi-Fi” can include communications governed by the IEEE 802.11 standards, Bluetooth®, HiperLan (a set of wireless standards, comparable to the IEEE 802.11 standards, used primarily in Europe), and other technologies used in wireless communications. The term “cellular communications” can include communications governed by the Long-Term Evolution (LTE) standard described by the 3^{rd} Generation Partnership Project (3GPP), the third generation of mobile communications technology (3G) standard, the Global System for Mobile Communications (GSM) standard, and/or other mobile phone standards and/or technologies. In addition, although described herein in terms of exchanging data frames between wireless devices, the example embodiments may be applied to the exchange of any data unit, packet, and/or frame between devices.

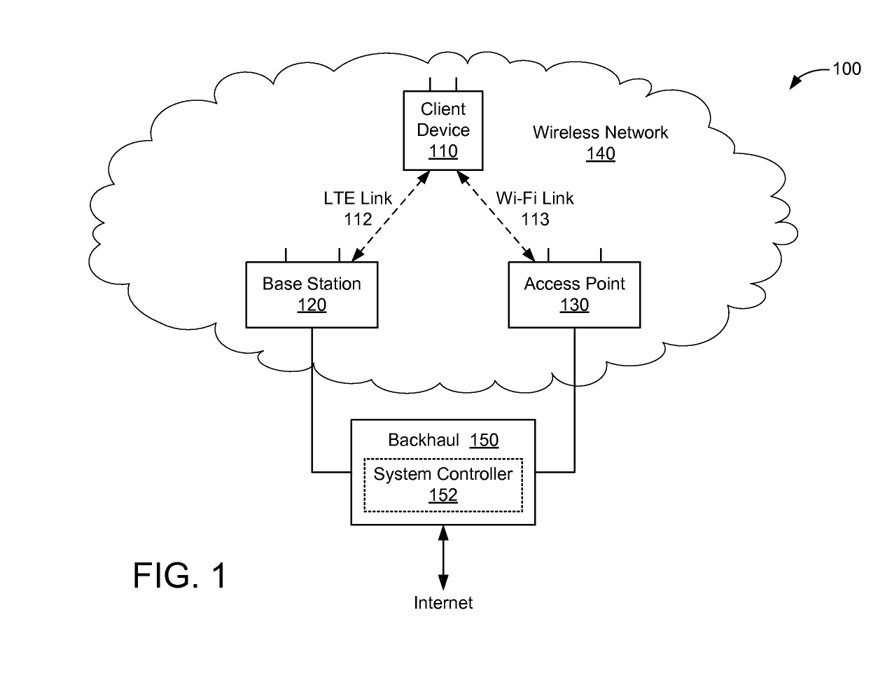

FIG. 1 shows an example wireless communications system 100 within which the example embodiments may be implemented. The system 100 is shown to include a client device 110, a base station 120, and an access point 130. The base station 120 and access point 130 are coupled to a backhaul 150, which serves as an intermediate link to core network resources operated and/or maintained by a carrier or service provider (e.g., the Internet). The backhaul 150 may comprise a network of wired and/or wireless connections. The base station 120 and access point 130 may collectively form a wireless network 140 of the wireless communications system 100, for example, by facilitating wireless communications between the client device 110 and the core network resources (e.g., the Internet). Although only one base station 120 and one access point 130 are shown in FIG. 1, for simplicity, it is to be understood that the wireless network 140 may be formed by any number of base stations (e.g., such as base station 120) and any number of access points (e.g., such as access point 130).

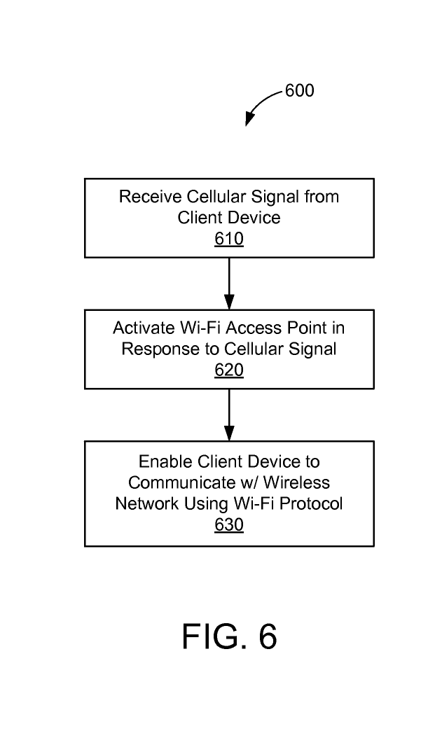

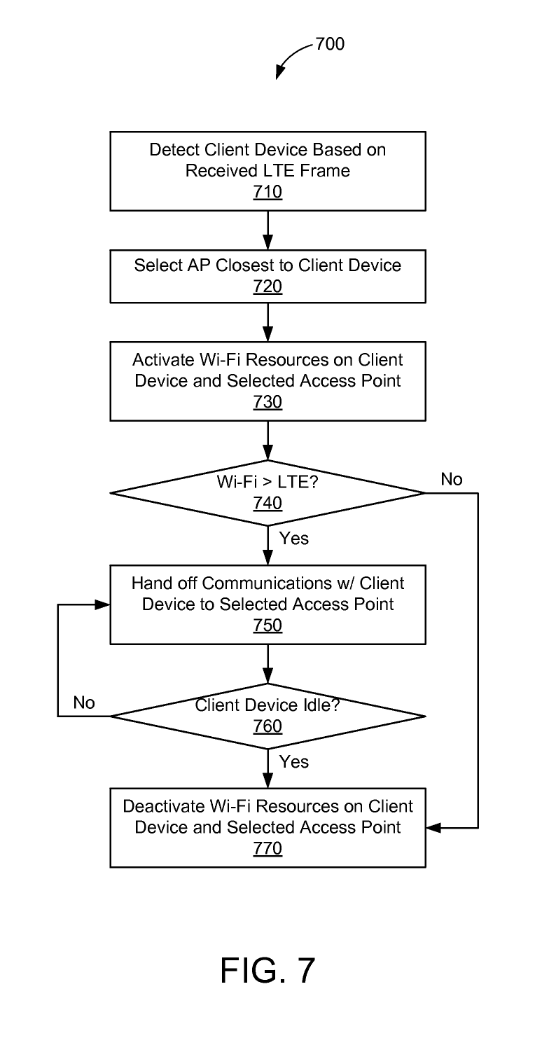

The client device 110 may be any suitable device enabled for wireless communications including, for example, a cell phone, personal digital assistant (PDA), tablet device, laptop computer, or the like. The client device 110 may also be referred to as user equipment (UE), a wireless station (STA), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, the client device 110 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The base station 120 may be any suitable device that allows one or more wireless devices to connect to a network (e.g., a cellular network, wide area network (WAN), metropolitan area network (MAN), and/or the Internet) via the base station 120 using LTE, 3G, GSM, or any other suitable wireless communication standards. For at least one embodiment, the base station 120 may include one or more transceivers, a network interface, one or more processing resources, and one or more memory resources. The one or more transceivers may include cellular transceivers (e.g., LTE transceivers), and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The access point 130 may be any suitable device that allows one or more wireless devices to connect to a network (e.g., a local area network (LAN), WAN, MAN, and/or the Internet) via the access point 130 using Wi-Fi, Bluetooth, or any other suitable wireless communication standards. For some embodiments, the access point 130 may be a software enabled access point (SoftAP) operating on a mobile (e.g., battery-powered) device. Depending on the application, a SoftAP may operate as a conventional access point or as a client device (e.g., such as client device 110). For at least one embodiment, the access point 130 may include one or more transceivers, a network interface, one or more processing resources, and one or more memory resources. The one or more transceivers may include Wi-Fi transceivers, Bluetooth transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The one or more transceivers of the client device 110, base station 120, and/or access point 130 may include Wi-Fi transceivers, Bluetooth transceivers, cellular transceivers, and/or other suitable radio frequency (RF) transceivers (not shown for simplicity) to transmit and receive wireless communications signals. Each transceiver may communicate with other wireless devices in distinct operating frequency bands and/or using distinct communications protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with the LTE standard (e.g., between 700 MHz and approximately 3.9 GHz) and/or in accordance with other cellular protocols (e.g., 3G, GSM, etc.). In some embodiments, the transceivers included within the client device 110, base station 120, and/or access point 130 may be any technically feasible transceiver such as a ZigBee transceiver described by the ZigBee specification, a Wi-Gig transceiver, and/or a HomePlug transceiver described by a specification from the HomePlug Alliance.

In example embodiments, the Wi-Fi resources (e.g., Wi-Fi radios in the client device 110 and/or access point 130) of the wireless network 140 are deactivated (e.g., to conserve power) when no data signals are being communicated over the wireless medium. For example, deactivating a Wi-Fi resource (e.g., a Wi-Fi radio) may place the resource in a “deep sleep” state, whereby the Wi-Fi resource is powered on but prevented from transmitting Wi-Fi signals over the wireless medium. Thus, when the Wi-Fi resource is activated (e.g., returned from the deep sleep state), it may begin transmitting Wi-Fi signals with little or no delay (e.g., since the Wi-Fi resource remains powered on).

For example, the Wi-Fi radio (e.g., including a Wi-Fi transceiver and/or processing resources) on the client device 110 may be deactivated when the client device 110 is not transmitting Wi-Fi data signals to, and/or receiving Wi-Fi data signals from, the access point 130 (e.g., or any other access points in the wireless network 140). When the Wi-Fi radio is deactivated, the client device 110 may be prevented from scanning for nearby access points (e.g., which may unnecessarily drain energy from the client device 110). Similarly, the access point 130 may be deactivated when it is not transmitting Wi-Fi data signals to, and/or receiving Wi-Fi data signals from, the client device 110 (e.g., or any other client devices in the wireless network 140). When the access point 130 is deactivated, it may be prevented from broadcasting beacon frames (e.g., which may unnecessarily drain energy from the access point 130).

The client device 110 may remain connected to the wireless network 140 via an LTE link 112 with the base station 120, regardless of whether the Wi-Fi resources of the wireless network 140 are activated or deactivated. For example, the base station 120 may remain active even if it is not transmitting cellular data signals to, and/or receiving cellular data signals from, the client device 110. Similarly, the cellular radio (e.g., including a cellular transceiver and/or processing resources) on the client device 110 may remain in an active state even if it is not transmitting cellular data signals to, and/or receiving cellular data signals from, the base station 120.

In example embodiments, the Wi-Fi resources of the wireless network 140 may be activated (or reactivated) when the client device 110 initiates a cellular communication with the base station 120. More specifically, activation (and deactivation) of the Wi-Fi resources may be controlled by a system controller 152 coupled to both the base station 120 and the access point 130 (e.g., via the backhaul 150). For example, the client device 110 may transmit an LTE signal (e.g., corresponding to a data frame) to the base station 120. The system controller 152 may detect the LTE frame sent by the client device 110, and trigger activation of the Wi-Fi resources of wireless network 140. For example, in response to detecting the LTE frame, the system controller 152 may restore the Wi-Fi radios (and/or other Wi-Fi resources) of client device 110 and access point 130 to an active state.

For some embodiments, the system controller 152 may facilitate the establishment of a Wi-Fi link 113 between the client device 110 and the access point 130. For example, the system controller 152 may instruct the access point 130 to broadcast beacon frames on a particular channel and/or to use a particular network key. The system controller 152 may also instruct the client device 110 to scan the same channel and/or to use the same network key (e.g., as used by the access point 130) when attempting to connect to the access point 130. After the Wi-Fi link 113 is established, the system controller 152 may hand off any subsequent communications between the client device 110 and the base station 120 to the access point 130.

Handing off wireless communications to the access point 130 may help reduce the load on the base station 120 while continuing to maintain a connection between the client device 110 and the core network of the wireless communications system 100 (e.g., the Internet). Moreover, selectively activating (and deactivating) Wi-Fi resources in an “on-demand” manner (e.g., only when the client device 110 initiates a data communication with the wireless network 140) may help reduce power consumption of the client device 110 and access point 130.

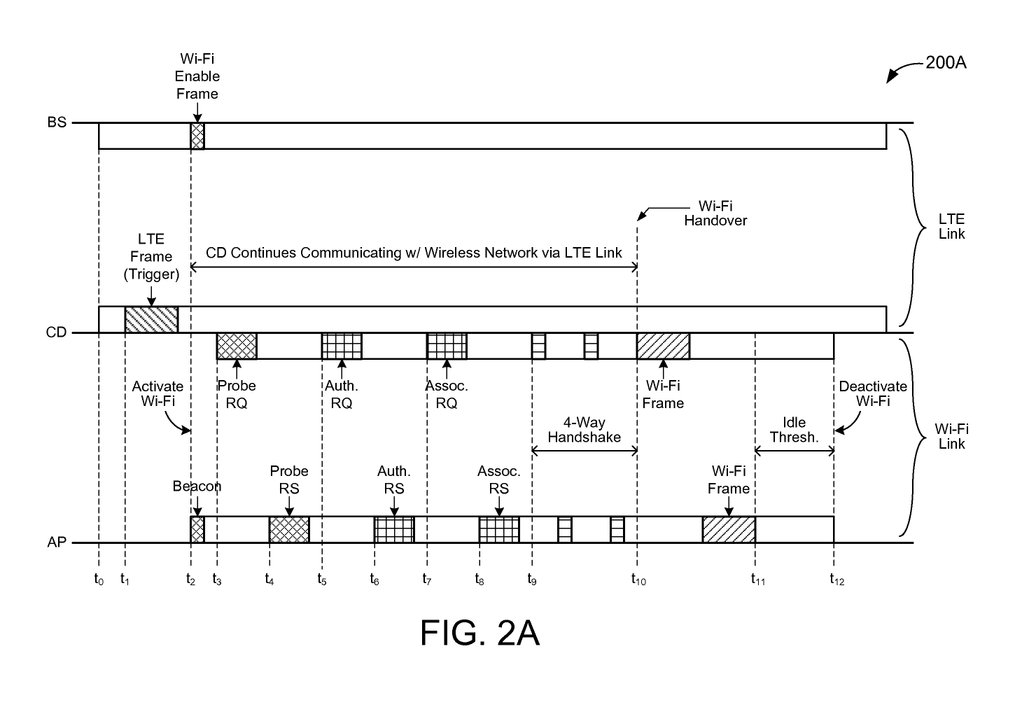

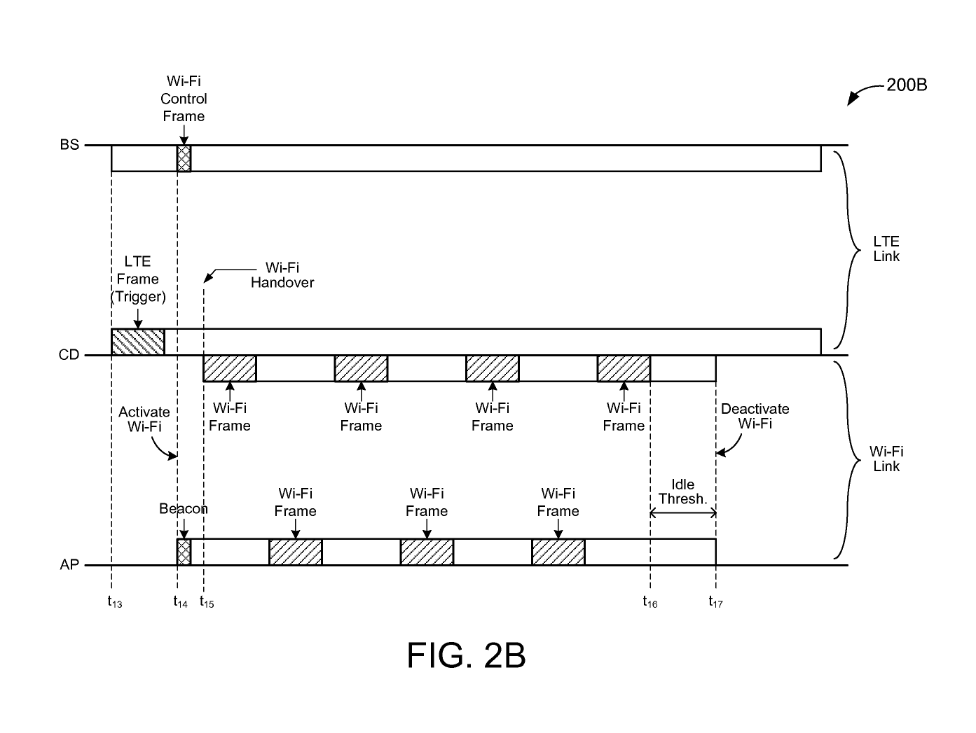

FIGS. 2A and 2B show example timing diagrams 200A and 200B, respectively, depicting selective activation and deactivation of Wi-Fi resources in a wireless network. For purposes of discussion herein, the base station (BS), client device (CD), and access point (AP) may be base station 120, client device 110, and access point 130, respectively, of FIG. 1.

With reference to FIG. 2A, the LTE link 112 between the client device 110 and the base station 120 is initially active, at time t₀, whereas a Wi-Fi link 113 between the client device 110 and the access point 130 has not yet been established. For example, one or more Wi-Fi resources (e.g., Wi-Fi radios) of the client device 110 and/or the access point 130 may be deactivated (e.g., and thus prevented from communicating with one another using Wi-Fi communication protocols). At time t₁, the client device 110 initiates a communication with the wireless network 140 by transmitting an LTE frame to the base station 120 (e.g., via the LTE link 112). In example embodiments, the LTE frame may act as a trigger for activating (e.g., establishing) a Wi-Fi link 113 between the client device 110 and access point 130.

At time t₂, the access point 130 returns (e.g., from a deep sleep state) to an active state and begins broadcasting beacon frames on a Wi-Fi channel. The base station 120 also transmits a Wi-Fi enable frame to the client device 110 (e.g., at time t₂) via the LTE link 112. The Wi-Fi enable frame causes the client device 110 to activate its Wi-Fi radio, at time t₃, and begin broadcasting probe requests (RQ) over a Wi-Fi channel (e.g., to scan for nearby access points). At time t₄, the access point 130 sends a probe response (RS) back to the client device 110 to notify the client device 110 of its Wi-Fi capabilities. For some embodiments, the client device 110 and access point 130 may broadcast their respective management frames (e.g., beacon frames, probe request frames, probe response frames, etc.) over a predetermined Wi-Fi channel.

To establish a Wi-Fi connection between the client device 110 and the access point 130, the client device 110 sends an authentication request to the access point 130 at time t₅, and the access point 130 sends an authentication response back to the client device 110 at time t₆. The exchange of authentication information (e.g., from times t₅ to t₆) may correspond with a low-level authentication process described by the IEEE 802.11 specification. The client device 110 then sends an association request to the access point 130 at time t₇, and the access point 130 sends an association response back to the client device 110 at time t₈. During the association process (e.g., from times t₇ to t₈), the client device 110 and access point 130 negotiate one or more capabilities to be used for subsequent wireless communications with each other. Once associated with one another, the client device 110 and access point 130 may perform a 4-way handshake, from time t₉ to time t₁₀, to complete the connection process. For example, the client device 110 and access point 130 may exchange Extensible Authentication Protocol over LAN (EAPoL) frames with one another to generate a pairwise transient key (PTK) to be used for encrypting (and decrypting) Wi-Fi communications.

While the Wi-Fi link 113 is still being set up (e.g., from times t₂ to t₁₀), the client device 110 may continue communicating with the wireless network 140 via the LTE link 112 (e.g., by exchanging LTE frames with the base station 120). However, after the client device 110 is connected to the access point 130 (e.g., at time t₁₀), the client device 110 may hand off subsequent wireless communications (e.g., intended for the base station 120) to the access point 130. For example, the client device 110 may continue to communicate with the wireless network 140 (e.g., without using the LTE link 112) by exchanging Wi-Fi frames with the access point 130 from time t₁₀ to time t₁₁. For some embodiments, the client device 110 may hand off wireless communications to the access point 130 (e.g., at time t₁₀) only if the quality of the Wi-Fi link 113 is superior to the quality of the LTE link 112 (e.g., greater bandwidth, lower latency, less interference, etc.).

If no activity is detected over the Wi-Fi link 113 for at least a threshold duration (e.g., an “idle threshold”), the client device 110 and access point 130 may subsequently deactivate their respective Wi-Fi resources. For example, at time t₁₂, the idle threshold has been reached (e.g., neither the client device 110 nor the access point 130 has transmitted a Wi-Fi frame over the Wi-Fi link 113 since time t₁₁). Accordingly, the Wi-Fi radios in the client device 110 and/or the access point 130 may return to the deep sleep state (e.g., at time t₁₂). The client device 110 and access point 130 are thus prevented from broadcasting probe requests and beacon frames, respectively (e.g., after time t₁₂). However, the client device 110 may remain actively connected to the wireless network 140 via the LTE link 112 with the base station 120.

In example embodiments, the Wi-Fi link 113 between the client device 110 and access point 130 may be maintained even after it is deactivated (e.g., or rendered inactive). For example embodiments, the client device 110 does not tear down its connection with the access point 130 after the idle threshold has expired (e.g., at time t₁₂). Rather, the client device 110 merely ceases communications (e.g., broadcasting probe requests) over the Wi-Fi link 113. Similarly, the access point 130 does not tear down its connection with the client device 110 after the idle threshold has expired (e.g., at time t₁₂). Rather, the access point 130 also ceases communications (e.g., broadcasting beacons) over the Wi-Fi link 113. This may allow faster handover of communications between the base station 120 and the access point 130 the next time the client device 110 initiates a communication with the wireless network 140.

For example, with reference to FIG. 2B, the client device 110 initiates a subsequent communication with the wireless network 140, at time t₁₃, by transmitting another LTE frame to the base station 120 (e.g., via the LTE link 112). As described above, the LTE link 112 may act as a trigger for reactivating the Wi-Fi link 113 between the client device 110 and access point 130. At time t₁₄, the access point 130 returns (e.g., from the deep sleep state) to an active state and begins broadcasting beacon frames on the Wi-Fi channel. The base station 120 also transmits a Wi-Fi enable frame to the client device 110 (e.g., at time t₁₄) via the LTE link 112. The Wi-Fi enable frame causes the client device 110 to reactivate its Wi-Fi radio at time t₁₅.

Because the Wi-Fi link 113 between the client device 110 and access point 130 was previously established (e.g., at time t₁₀, with reference to FIG. 2A), the client device 110 and access point 130 do not need to repeat the authentication, association, and/or handshake processes (e.g., which took place between times t₅ to t₁₀). Thus, the client device 110 may immediately hand off wireless communications (e.g., intended for the base station 120) to the access point 130 (e.g., at time t₁₅). For some embodiments, the client device 110 may hand off wireless communications to the access point 130 only if the quality of the Wi-Fi link 113 is superior to the quality of the LTE link 112.

At time t₁₇, neither the client device 110 nor the access point 130 has transmitted any Wi-Fi data frames over the Wi-Fi link 113 for at least a threshold duration (e.g., since the last Wi-Fi frame was sent by the client device 110, at time t₁₆). Accordingly, the Wi-Fi radios in the client device 110 and/or access point 130 may return to a deep sleep state (e.g., at time t₁₇). The client device 110 and access point 130 are once again prevented from broadcasting probe requests and beacon frames, respectively (e.g., after time t₁₇). However, the client device 110 remains actively connected to the wireless network 140 via the LTE link 112 with the base station 120.

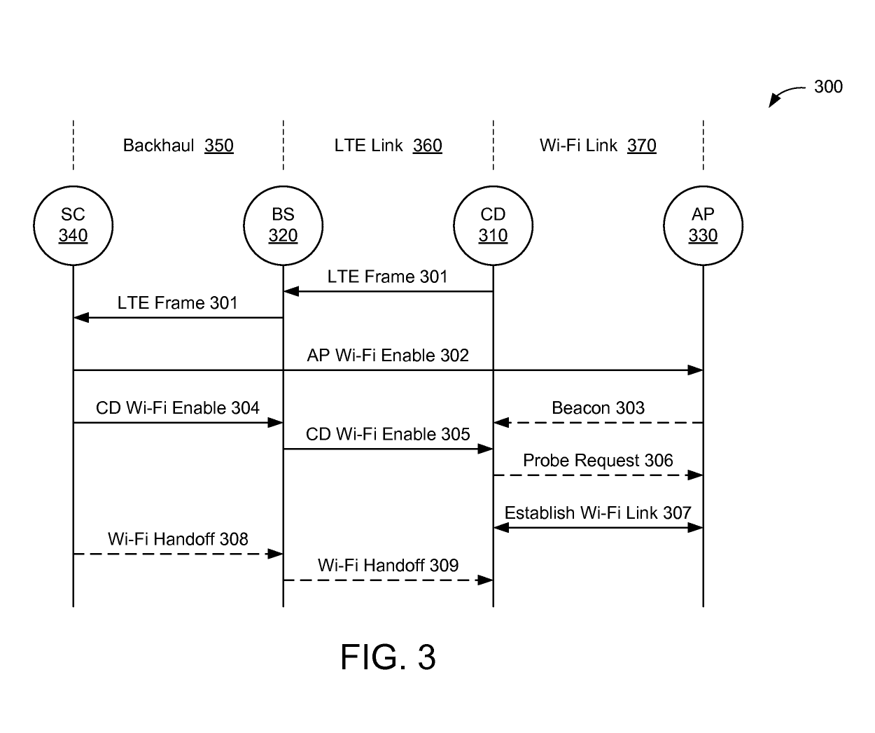

FIG. 3 shows an example sequence diagram 300 depicting a backhaul-controlled activation of a Wi-Fi link between a client device and a wireless communications system. The system controller 340 is coupled to both the base station 320 and the access point 330 via a backhaul connection 350. For some embodiments, the backhaul connection 350 may comprise wired and/or wireless connections. The client device 310 is connected to the base station 320 via an LTE (e.g., cellular) link 360, and may be connected to the access point 330 via a Wi-Fi link 370. In the example of FIG. 3, the LTE link 360 is always active, whereas the Wi-Fi link 370 is initially inactive.

The client device 310 initiates a communication with the base station 320 by sending an LTE frame 301 over the LTE link 360. The base station 320 forwards the LTE frame 301 to the backhaul connection 350, where it is detected by the system controller 340. Upon detecting the LTE frame 301 sent by the client device 310, the system controller 340 sends an AP Wi-Fi enable signal 302 to the access point 330. The AP Wi-Fi enable signal 302 causes the access point 330 to activate one or more of its Wi-Fi resources (e.g., by returning from a deep sleep state) and begin broadcasting beacon frames 303. For some embodiments, the AP Wi-Fi enable signal 302 may include information identifying a predetermined channel (e.g., on which the access point 330 is to broadcast the beacon frames 303) and/or a network key (e.g., used to authenticate client devices requesting to connect to the access point 330).

The system controller 340 also sends a CD Wi-Fi enable signal 304 to the base station 320. The base station 320 transmits the CD Wi-Fi enable signal 304 to the client device 310 (e.g., as a CD Wi-Fi enable frame 305) via the LTE link 360. The CD Wi-Fi enable signal 304 causes the client device 310 to activate one or more of its Wi-Fi resources (e.g., by returning from a deep sleep state) and begin broadcasting probe request frames 306. For some embodiments, the CD Wi-Fi enable frame 305 may include information identifying the predetermined channel on which the access point 330 is to operate (e.g., to broadcast beacon frames 303), and/or may include the network key used by the access point 330 to authenticate client devices.

The client device 310 may identify the access point 330 based on the beacon frames 303 and/or based on probe response frames sent by the access point 330 in response to the probe request frames 306 sent from the client device 310. The client device 310 may then establish a Wi-Fi link 307 with the access point 330, for example, by performing an authentication, association, and handshake operation with the access point 330. Once the client device 310 is connected to the access point 330 via the Wi-Fi link 370, the system controller 340 may selectively enable the base station 320 to hand off subsequent communications with the client device 310 to the access point 330.

In example embodiments, the system controller 340 may allow the client device 310 to continue communicating solely with the base station 320 via LTE link 360 if the performance of the Wi-Fi link 370 is inferior to that of the LTE link 360. For example, the system controller 340 may compare the performance of the LTE link 360 with that of the Wi-Fi link 370 based on communications between the client device 310 and base station 320 or access point 330, respectively. The system controller 340 may then deactivate the Wi-Fi link 370 if it does not offer better performance (e.g., greater bandwidth, lower latency, higher quality of service, less interference, etc.) than the LTE link 360.

In other embodiments, the system controller 340 may send a Wi-Fi handoff signal 308 to the base station 320 if the performance of the Wi-Fi link 370 is superior to that of the LTE link 360 (e.g., offers greater bandwidth, lower latency, higher quality of service, less interference, etc.). The base station 320 may cease communications with the client device 310 upon receiving the Wi-Fi handoff signal 308, and may send a corresponding Wi-Fi handoff frame 309 to the client device 310 (e.g., via the LTE link 360). Upon receiving the Wi-Fi handoff frame 309, the client device 310 ceases communications with the base station 320 and redirects any subsequent and/or ongoing communications to the access point 330 (e.g., via the Wi-Fi link 370).

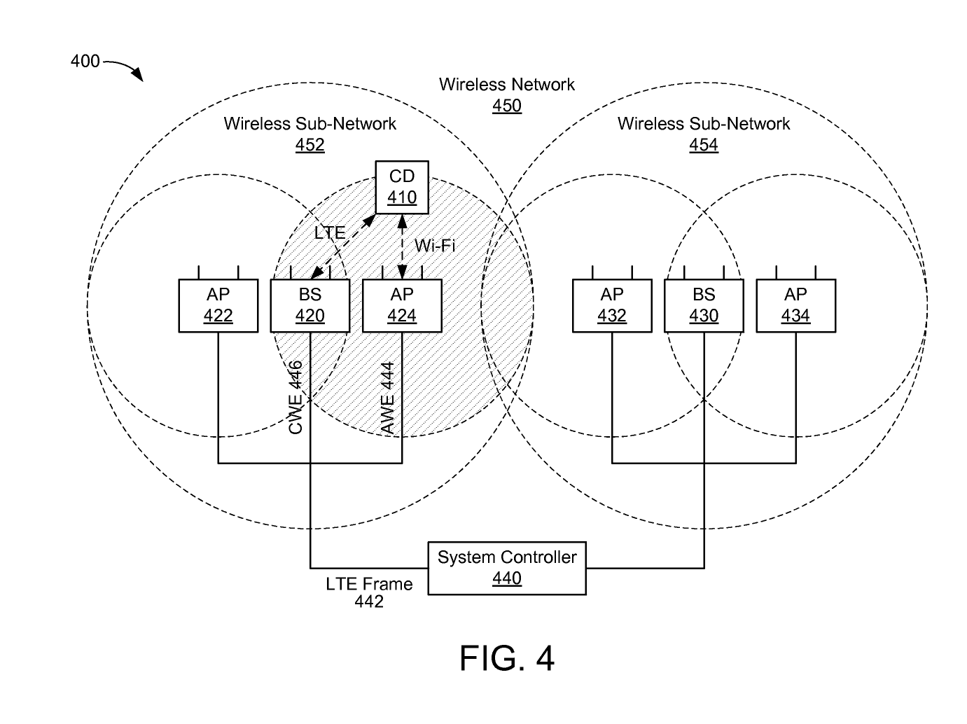

FIG. 4 shows an example wireless communications system 400 including a wireless network comprising multiple access points within which the example embodiments may be implemented. The wireless communications system 400 includes a client device 410, base stations 420 and 430, access points 422, 424, 432, and 434, and a system controller 440. For purposes of discussion herein, the client device 410 and system controller 440 may be embodiments of client device 110 and system controller 152, respectively, of FIG. 1. Each of the base stations 420 and 430 may be an embodiment of base station 120 of FIG. 1, and each of the access points 422, 424, 432, and 434 may be an embodiment of access point 130 of FIG. 1.

The base stations 420 and 430 and access points 422, 424, 432, and 434 collectively form a wireless network 450, and are coupled to the system controller 440 via a backhaul (not shown for simplicity). For example, the client device 410 may access core network resources (e.g., the Internet) by communicating with any of the base stations and/or access points in the wireless network 450. The wireless network 450 may be subdivided into wireless sub-networks 452 and 454. For example, the first wireless sub-network 452 may be provided by base station 420 and access points 422 and 424. The second wireless sub-network 454 may be provided by base station 430 and access points 432 and 434.

In example embodiments, the Wi-Fi resources of the wireless network 450 are deactivated (e.g., prevented from broadcasting beacon and/or probe request frames) as long as no data signals are being communicated over the wireless medium. For simplicity, it may be assumed that the client device 410 is the only client device within wireless range of the wireless network 450. Thus, the access points 422, 424, 432, and 434 may be deactivated (e.g., prevented from broadcasting beacon frames) as long as the client device 410 is idle (e.g., not transmitting and/or receiving data signals via the wireless network 450). Similarly, the Wi-Fi radio of the client device 410 may be deactivated (e.g., prevented from scanning for nearby access points) while the client device 410 is idle.

The client device 410 may remain connected to the wireless network 450 via an LTE (e.g., cellular) link with a nearest base station. In the example shown, the client device 410 is within wireless range of the first wireless sub-network 452, but is outside the range of the second wireless sub-network 454. Thus, the client device 410 may be connected to the wireless network 450 via an LTE link with base station 420. For some embodiments, the base stations 420 and 430 may remain active even if they are not transmitting cellular data signals to, and/or receiving cellular data signals from, the client device 410. Similarly, the cellular radio on the client device 410 may remain in an active state even if it is not transmitting cellular data signals to, and/or receiving cellular data signals from, either of the base stations 420 or 430.

In example embodiments, one or more Wi-Fi resources of the wireless network 450 may be selectively activated (or reactivated) when the client device 410 initiates a cellular communication with the wireless network 450. For example, the client device 410 may transmit an LTE frame 442 to base station 420 via a respective LTE link. The LTE frame 442 is sent by the base station 420 to the system controller 440 (e.g., via the backhaul), which triggers activation of one or more Wi-Fi resources of the wireless network 450. For some embodiments, in response to detecting the LTE frame 442, the system controller 440 may selectively activate one or more of the access points 422, 424, 432, and/or 434 to provide Wi-Fi access for the client device 410. For example, the system controller 440 may select the access point that is closest to and/or provides the greatest Wi-Fi performance for the client device 410.

For some embodiments, the system controller 440 may activate the access point that is closest in proximity to the client device 410. For example, the system controller 440 may determine a location of the client device 410 based on received signal strength indicator (RSSI) values, base station triangulation, global positioning satellite (GPS) data, and/or other geolocation information. The system controller 440 may then determine, based on the location of the client device 410, that access point 424 is closest in proximity to the client device 410. Accordingly, the system controller 440 may send an AP Wi-Fi enable (AWE) signal 444 to access point 424, thereby enabling the access point 424 to begin broadcasting beacon frames.

In an alternative embodiment, the system controller 440 may activate any access points that are within the same wireless sub-network as the client device 410. For example, the system controller 440 may detect that the client device 410 is in the first wireless sub-network 452 because the LTE frame 442 is received by base station 420. Accordingly, the system controller 440 may send the AWE signal 444 to both access points 422 and 424 belonging to the first wireless sub-network 452. As described above, the AWE signal 444 activates the Wi-Fi radios of the access points 422 and 424, for example, so that the access points 422 and 424 may begin broadcasting beacon frames (and respond to probe requests).

The system controller 440 also sends a CD Wi-Fi enable (CWE) signal 446 to the base station 420, which forwards the CWE signal 446 (e.g., as a CWE frame) to the client device 410. The CWE signal 446 enable the client device 410 to begin scanning for nearby access points (e.g., by broadcasting probe request frames). For some embodiments, the AWE signal 444 may indicate a predetermined Wi-Fi channel (e.g., on which the access point 424 is to operate) and a network key (e.g., to be used by the access point 424 to authenticate client devices requesting access to the AP 424). Similarly, the CWE signal 446 may also indicate the predetermined Wi-Fi channel (e.g., on which the client device 410 is to scan for the access point 424) and the network key (e.g., to be used by the client device 410 to authenticate with the access point 424).

The system controller 440 may then compare the performance of the Wi-Fi link (e.g., between the client device 410 and the access point 424) with that of the LTE link (e.g., between the client device 410 and the base station 420) to determine which wireless protocol (e.g., LTE or Wi-Fi) offers superior performance (e.g., greater bandwidth, lower latency, higher quality of service, less interference, etc.). If the performance of the LTE link is superior to the performance of the Wi-Fi link, the system controller 440 may allow the client device 410 to continue communicating with the wireless network 450 only through the base station 420 (e.g., and deactivate the access point 424). If the performance of the Wi-Fi link is superior to the performance of the LTE link, the system controller 440 may instruct the base station 420 to hand off subsequent and/or ongoing communications with the client device 410 to the access point 424 (e.g., as described above with reference to FIG. 3).

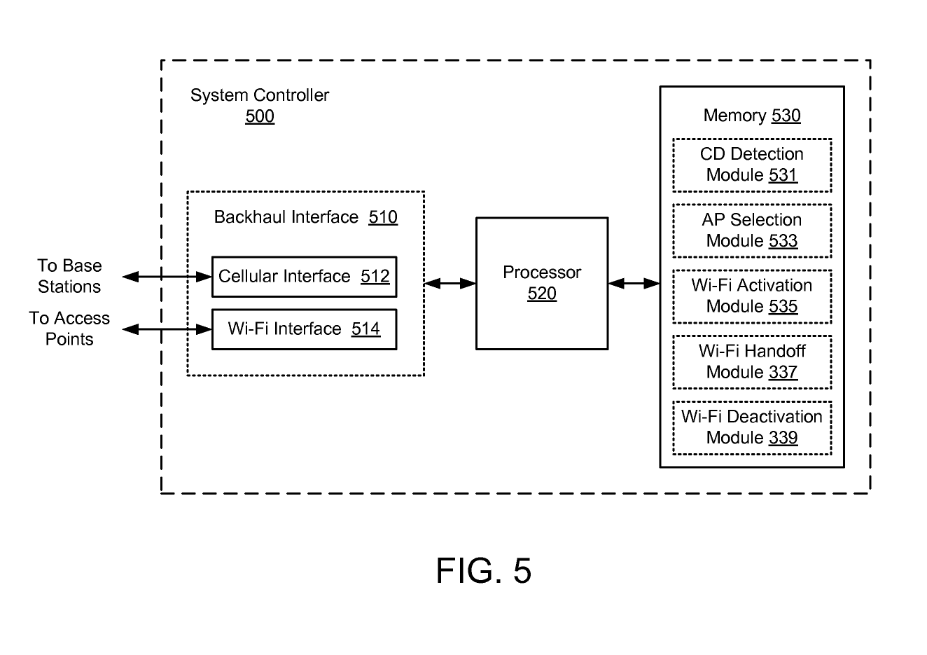

FIG. 5 shows a system controller 500 for a wireless communications system in accordance with example embodiments. The system controller 500 may be one embodiment of system controller 152 of FIG. 1. The system controller 500 includes at least a backhaul interface 510, a processor 520, and a memory 530. The backhaul interface 510 includes a cellular interface 512 and a Wi-Fi interface 514. The cellular interface 512 may be coupled to one or more base stations via a first set of wired and/or wireless backhaul connections (not shown for simplicity). The Wi-Fi interface 514 may be coupled to one or more access points via a second set of wired and/or wireless backhaul connections (not shown for simplicity).

Processor 520, which is coupled to the backhaul interface 510 and memory 530, may be any suitable one or more processors capable of executing scripts or instructions of one or more software programs stored in the system controller 500 (e.g., within memory 530). For purposes of discussion herein, processor 520 is shown in FIG. 5 as being coupled between the backhaul interface 510 and memory 530. For actual embodiments, the backhaul interface 510, processor 520, and/or memory 530 may be connected together using one or more buses (not shown for simplicity).

Memory 530 may include a non-transitory computer-readable medium (e.g., one or more nonvolatile memory elements, such as EPROM, EEPROM, Flash memory, a hard drive, etc.) that may store the following software modules:
a client device (CD) detection module 531 to detect when a client device attempts to initiate a wireless communication with a base station coupled to the system controller 500;
an access point (AP) selection module 533 to select one or more access points, coupled to the system controller 500, that are closest to and/or within wireless range of the detected client device;
a Wi-Fi activation module 535 to activate Wi-Fi resources on the detected client device and/or selected access point(s);
a Wi-Fi handoff module 537 to selectively hand off communications with the client device from the base station to the selected access point(s) based at least in part on a performance comparison of the Wi-Fi link relative to the LTE link; and
a Wi-Fi deactivation module 539 to deactivate the Wi-Fi resources on the detected client device and/or selected access point(s) when the Wi-Fi link is not in use.
   Each software module includes instructions that, when executed by processor 520, cause system controller 500 to perform the corresponding functions. The non-transitory computer-readable medium of memory 530 thus includes instructions for performing all or a portion of the operations depicted in FIGS. 6 and 7.

For example, processor 520 may execute the CD detection module 531 to detect when a client device attempts to initiate a wireless communication with a base station coupled to the system controller 500. Processor 520 may also execute the AP selection module 533 to select one or more access points, coupled to the system controller 500, that are closest to and/or within wireless range of the detected client device. Further, processor 520 may execute the Wi-Fi activation module 535 to activate Wi-Fi resources on the detected client device and/or selected access point(s). Still further, processor 520 may execute the Wi-Fi handoff module 537 to selectively hand off communication with the client device from the base station to the selected access point(s) based at least in part on a performance comparison of the Wi-Fi link relative to the LTE link. Processor 520 may also activate the Wi-Fi deactivation module 539 to deactivate the Wi-Fi resources on the detected client device and/or selected access point(s) when the Wi-Fi link is not in use (e.g., or is idle for at least a threshold duration).

FIG. 6 shows a flowchart depicting an example operation 600 for activating Wi-Fi resources in a wireless network in response to a cellular communications signal. With reference, for example, to FIG. 1, the example operation 600 may be performed by the system controller 152 to selectively enable Wi-Fi communications between the client device 110 and access point 130.

The system controller 152 first receives a cellular signal from the client device 110 (610). In example embodiments, the LTE link 112 between the client device 110 and the base station 120 is always active (e.g., LTE radios in the respective devices are in an active state). Thus, the client device 110 may transmit an LTE signal (e.g., corresponding to a data frame) to the base station 120 via the LTE link 112. The base station 120 may then forward the LTE frame to the system controller 152 via the backhaul 150.

The system controller 152 then activates the Wi-Fi access point 130 in response to the cellular signal (620). In example embodiments, the Wi-Fi link 113 between the client device 110 and access point 130 is initially deactivated (e.g., Wi-Fi radios in the client device 110 and access point 130 are in a deep sleep state). Thus, the client device 110 is initially prevented from scanning for nearby access points (e.g., by broadcasting probe request frames), and the access point 130 is prevented from broadcasting beacon frames. Upon detecting the LTE frame, the system controller 152 may restore the access point 130 (e.g., or one or more Wi-Fi radios of the access point 130) to an active state. This enables the access point 130 to begin broadcasting beacon frames.

Finally, the system controller 152 enables the client device 110 to communicate with the wireless network 140 using the Wi-Fi protocol (630). For example, upon detecting the LTE frame, the system controller 152 may restore the Wi-Fi radios of the client device 110 to an active state. This enables the client device 110 to begin scanning for access points (e.g., by broadcasting probe request frames). Once the client device 110 discovers the access point 130 (or vice-versa), a Wi-Fi link 113 may be established between the client device 110 and access point 130. The system controller 152 may then enable subsequent and/or ongoing communications between the client device 110 and the wireless network 140 to be routed through the access point 130 (e.g., in lieu of the base station 120).

FIG. 7 shows a flowchart depicting an example operation 700 for controlling an activation and deactivation of Wi-Fi resources in a wireless network. With reference, for example, to FIG. 4, the example operation 700 may be performed by the system controller 440 to selectively enable and/or disable Wi-Fi communications between the client device 110 and an access point in the wireless network 450.

The system controller 440 detects a client device 410 based on a received LTE frame (710). In example embodiments, any communications between the client device 410 and the wireless communications system 400 are initiated over an LTE link between the client device 410 and a respective base station in the wireless network 450. Moreover, the client device 110 may be actively connected to the wireless network 450 via an LTE link as long as the client device 410 is within wireless range of at least one of the base stations 420 and/or 430 of the wireless network 450. Thus, the client device 410 may initiate a communication with the wireless network 450 by transmitting an LTE frame 442 to base station 420. The base station may then forward the LTE frame 442 to the system controller 440 (e.g., one or more backhaul connections).

The system controller 440 then selects an access point closest in proximity to the client device 410 (720). For example, the system controller 440 may detect that the client device 410 is within the first wireless sub-network 452 because the LTE frame was received by base station 420. Further, the system controller 440 may detect a more accurate location of the client device 410 based at least in part on RSSI data, base station triangulation, GPS data, and/or other geolocation information provided by the client device 410 and/or base station 420. Based on the location of the client device 410, the system controller 440 may select access point 424 as the access point closest in proximity to the client device 410.

Wi-Fi resources on the client device 410 and the selected access point 424 are activated in response to the LTE frame (730). In example embodiments, the Wi-Fi radios in the client device 410 and access points 422, 424, 432, and 434 are initially deactivated (e.g., placed in a deep sleep state). Upon detecting the LTE frame 442, the system controller 440 may send respective Wi-Fi enable signals 444 and 446 to the client device 410 (e.g., by way of the base station 420) and access point 424. The Wi-Fi enable signals 444 and 446 cause the Wi-Fi radios in the client device 410 and access point 422, respectively, to return to an active state. More specifically, the CWE signal 446 enables the client device 410 to begin scanning for nearby access points (e.g., by broadcasting probe request frames), and the AWE signal 444 enables the access point 424 to begin broadcasting beacon frames. For some embodiments, the Wi-Fi enable signals 444 and 446 may include matching configuration information (e.g., wireless channel and/or network key information) to facilitate the establishment of a Wi-Fi connection between the client device 410 and the access point 424.

The system controller 440 may compare the performance of the Wi-Fi link (e.g., between the client device 410 and access point 424) with the performance of the LTE link (e.g., between the client device 410 and base station 420) to determine whether to continue communicating with the client device 410 via the LTE link or to hand off communications to the Wi-Fi link (740). For example, if the performance of the LTE link is superior to the performance of the Wi-Fi link (as tested at 740), the system controller 440 may allow the client device 410 to continue communicating with the wireless network 450 by way of the base station only. Accordingly, the system controller 440 may proceed to deactivate the Wi-Fi resources on the client device 410 and the selected access point 424 (770).

If the performance of the Wi-Fi link is superior to the performance of the LTE link (as tested at 740), the system controller 440 may hand off communications with the client device 410 to the selected access point 424 (750). For example, the system controller 440 may instruct the base station 420 to hand off subsequent and/or ongoing communications with the client device 410 to the access point 424 (e.g., as described above with reference to FIG. 3). Thus, as long as the Wi-Fi resources of the client device 410 and access point 424 remain active, any communications between the client device 410 and the wireless communications system 400 are subsequently routed through access point 424 (e.g., in lieu of base station 420).

The system controller 440 may monitor the activity on the Wi-Fi link (e.g., between the client device 410 and access point 424) to determine whether the client device 410 has been idle for a threshold duration (760). As long as the idle threshold has not been reached (as tested at 760), the system controller 440 may allow the Wi-Fi resources on the client device 410 and access point 424 to remain active. For example, the client device 410 may scan for nearby access points (e.g., by broadcasting probe request frames), and the access point 424 may broadcast beacon frames.

If the client device 410 has been idle for at least the threshold duration (as tested at 760), the system controller 440 may subsequently deactivate the Wi-Fi resources on the client device 410 and access point 424 (770). For example, respective Wi-Fi radios on the client device 410 and access point 424 may return to the deep sleep state (e.g., powered on but prevented from transmitting and/or receiving Wi-Fi signals). Accordingly, the client device 410 may be prevented from broadcasting probe request frames, and the access point 424 may be prevented from broadcasting beacon frames.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific examples. It will, however, be evident that various modifications and changes may be made thereto without departing from the broader scope of the disclosure as set forth in the appended claims. For example, the method steps depicted in the flow charts of FIGS. 6 and 7 may be performed in other suitable orders, multiple steps may be combined into a single step, and/or some steps may be omitted (or further steps included). The specification and drawings are, accordingly, to be regarded in an illustrative sense rather than a restrictive sense.

What is claimed is:

1. A method of operating a wireless network, the method comprising:
receiving a cellular signal from a client device;
activating an access point in the wireless network in response to the cellular signal, wherein the access point transmits and receives Wi-Fi signals; and
enabling the client device to communicate with the wireless network, via the access point, using the Wi-Fi signals.

2. The method of claim 1, wherein activating the access point comprises:
enabling the access point to broadcast beacon frames.

3. The method of claim 1, wherein activating the access point comprises:
identifying a set of access points within wireless range of the client device; and
selecting the access point from the set of access points based at least in part on a proximity of the access point to the client device.

4. The method of claim 1, further comprising:
detecting that the client device has been idle for at least a threshold duration; and
deactivating the access point upon detecting that the client device has been idle for at least the threshold duration.

5. The method of claim 1, wherein the enabling further comprises:
providing a network key to the client device and the access point, the network key to authenticate the client device with the access point.

6. The method of claim 1, wherein the enabling further comprises:
activating a Wi-Fi radio on the client device in response to receiving the cellular signal.

7. The method of claim 6, wherein activating the Wi-Fi radio comprises:
enabling the client device to scan for one or more access points.

8. The method of claim 6, further comprising:
detecting that the client device has been idle for at least a threshold duration; and
deactivating the Wi-Fi radio on the client device upon detecting that the client device has been idle for at least the threshold duration.

9. The method of claim 1, wherein the cellular signal is based on a Long-Term Evolution (LTE) standard.

10. A wireless communications system comprising:
a base station to transmit and receive cellular signals;
an access point to transmit and receive Wi-Fi signals; and
a system controller, coupled to the base station and the access point, to:
receive a cellular signal from a client device via the base station;
activate the access point in response to the cellular signal; and
enable the client device to communicate with the wireless communications system, via the access point, using Wi-Fi signals.

11. The wireless communications system of claim 10, wherein the system controller is to activate the access point by:
enabling the access point to broadcast beacon frames.

12. The wireless communications system of claim 10, wherein the system controller is to activate the access point by:
identifying a set of access points in the wireless communications system that are within wireless range of the client device; and
selecting the access point from the set of access points based at least in part on a proximity of the access point to the client device.

13. The wireless communications system of claim 10, wherein the system controller is to further:
provide a network key to the client device and the access point, the network key to authenticate the client device with the access point.

14. The wireless communications system of claim 10, wherein the system controller is to further:
detect that the client device has been idle for at least a threshold duration; and
deactivate the access point upon detecting that the client device has been idle for at least the threshold duration.

15. The wireless communications system of claim 10, wherein the system controller is to enable the client device to communicate with the wireless communications system via the access point by:
activating a Wi-Fi radio on the client device in response to receiving the cellular signal.

16. The wireless communications system of claim 15, wherein activating the Wi-Fi radio on the client device enables the client device to scan for one or more access points.

17. The wireless communications system of claim 15, wherein the system controller is to further:
detect that the client device has been idle for at least a threshold duration; and
deactivate the Wi-Fi radio on the client device upon detecting that the client device has been idle for at least the threshold duration.

18. The wireless communications system of claim 10, wherein the cellular signal is based on a Long-Term Evolution (LTE) standard.

19. A wireless communications system, comprising:
means for receiving a cellular signal from a client device;
means for activating an access point in the wireless communications system in response to the cellular signal, wherein the access point transmits and receives Wi-Fi signals; and
means for enabling the client device to communicate with the wireless communications system, via the access point, using Wi-Fi signals.

20. The wireless communications system of claim 19, wherein the means for activating the access point is to:
enable the access point to broadcast beacon frames.

21. The wireless communications system of claim 19, wherein the means for activating the access point is to:
identify a set of access points within wireless range of the client device; and
select the access point from the set of access points based at least in part on a proximity of the access point to the client device.

22. The wireless communications system of claim 19, further comprising:
means for providing a network key to the client device and the access point, the network key to authenticate the client device with the access point.

23. The wireless communications system of claim 19, further comprising:
means for detecting that the client device has been idle for at least a threshold duration; and
means for deactivating the access point upon detecting that the client device has been idle for at least the threshold duration.

24. The wireless communications system of claim 19, wherein the means for enabling the client device to communicate with the wireless communications system via the access point is to:
activate a Wi-Fi radio on the client device in response to receiving the cellular signal.

25. The wireless communications system of claim 24, wherein the means for activating the Wi-Fi radio on the client device is to:
enable the client device to scan for one or more access points.

26. The wireless communications system of claim 24, further comprising:
means for detecting that the client device has been idle for at least a threshold duration; and
means for deactivating the Wi-Fi radio on the client device upon detecting that the client device has been idle for at least the threshold duration.

27. A non-transitory computer-readable storage medium containing program instructions that, when executed by a processor of a system controller of a wireless network, causes the system controller to:
receive a cellular signal from a client device;
activate an access point in the wireless network in response to the cellular signal, wherein the access point transmits and receives Wi-Fi signals; and
enable the client device to communicate with the wireless network, via the access point, using Wi-Fi signals.

28. The non-transitory computer-readable storage medium of claim 27, wherein execution of the instructions to activate the access point causes the system controller to:
enable the access point to broadcast beacon frames.

29. The non-transitory computer-readable storage medium of claim 27, wherein execution of the instructions to enable the client device to communicate with the wireless network causes the system controller to:
activate a Wi-Fi radio on the client device in response to receiving the cellular signal.

30. The non-transitory computer-readable storage medium of claim 29, wherein execution of the instructions to activate the Wi-Fi radio on the client device causes the system controller to:
enable the client device to scan for one or more access points.
